(19) United States
(12) Patent Application Publication
(10) Pub. No.: US 2012/0073689 A1
(43) Pub. Date: Mar. 29, 2012

(54) FAUCET STRUCTURE

(75) Inventors: Hsi Chia KO, CHANGHUA COUNTY (TW); Jui Feng KO, CHANGHUA COUNTY (TW)

(73) Assignee: CHUNG CHENG FAUCET CO., LTD., CHANGHUA COUNTY (TW)

(21) Appl. No.: 12/892,667

(22) Filed: Sep. 28, 2010

(51) Int. Cl. F16K 51/00

(52) U.S. Cl. 137/801

(57) ABSTRACT

An improved faucet structure includes an inlet pipe having a main metallic pipe and a non-toxic pressure and climate resistant plastic holding chamber that can be interchangeably used by multiple products. The main metallic pipe includes a ring groove with a larger diameter as a limiting element on the side thereof. The ring groove includes one or more holes thereon to further couple with even a larger diameter item. The holding chamber includes a connecting pipe disposed at a bottom end of thereof. The chamber includes two or more external leakage rings, and the rings are closely coupled to the internal wall of the main metallic pipe. This assembly reduces the needs of relying all metallic pipes, and the holding chamber is capable connecting to other faucet assemblies.

### BACKGROUND OF THE INVENTION

1. Field of the Invention

Embodiments of the invention generally relate to an improvement faucet structure. In particular, an improved faucet structure that includes an inlet pipe having a main metallic pipe and a non-toxic pressure and climate resistant plastic holding chamber that can be interchangeably used by multiple products. The chamber includes two or more external leakage rings, and the rings are closely coupled to the internal wall of the main metallic pipe. This assembly reduces the need of relying all metallic pipes, and the holding chamber is capable connecting to other faucet assemblies.

2. Background of the Invention

Based on existing practice, an inlet pipe for an existing faucet (see 10 of FIG. 1) includes an externally threaded metallic pipe 11 and a metallic holding chamber 12 at one end of the externally threaded metallic pipe. The metallic holding chamber 12 is coupled to a control valve 13 and is fitted with a leakage ring 14 and an elastic element 15 to achieve the optimal leakage prevention purpose. However, when the above faucet 10 is subjected to long exposure to water pressure or the faucet 10 is subjected to incidental impact, the faucet 10 structure is damaged. Because the holding chamber 12 and the externally threaded metallic pipe 10 are formed in one piece, the damage described above would require the replacement of the entire faucet 10. If one wishes to improve the strength of the faucet 10 by increasing the thickness of the externally threaded metallic pipe 11, the added metallic material further increases the overall cost and is not cost effective.

Referring to FIGS. 2-5, an inlet pipe 20′ structure mainly includes an integrated piece of metallic set that includes two pipes 21′ that have external threads with holding chambers 22′. The two holding chambers 22′ on each side is coupled to a conduit 23′ and is joined to one outlet 24′. It is noted that the outlet 24′ cannot be separated from the inlet pipe 20′. Or, as shown in FIGS. 6-7, the two pipes 21′ are joined to the same holding chamber 22′, and the holding chamber 22′ is coupled to the outlet 24′. However, the practices shown in above figures all include a metallic material for the inlet pipe 20′ and include the following shortcomings: (1) the metallic construction of the pipes often creates powdered bores, and these negatively affect the quality of the pipes and lead to malfunction. In addition, the process generates toxic materials and is harmful to the environment. (2) The walls of the metallic pipes are not smooth and can cause water to carry debris therefrom. (3) The inlet pipe 20′ is in an one-piece construction, have just one size. As such, it is difficult to fit to all different kinds of faucet plates. Therefore, it further reduces the value of the product and decreases the consumer's purchasing desire. (4) The examples shown in FIGS. 6-7 are welded to one integrated piece and lack flexibility in accommodating standardized usage.

### BRIEF SUMMARY OF THE INVENTION

Embodiments of the invention provide a structure of a faucet in which it uses the bottom end of the holding chamber to include a leakage ring in a connecting pipe coupled to a threaded pipe. As such, there is no need to have an external tool set to adjust or tighten the pipes and aspects of the invention can accommodate different faceplates to suit the user's needs. Benefits of embodiments of the invention further include adding strengthen to the overall structure of the pipes.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exploding view of a prior art.

FIG. 2 is an exploding view of another prior art (1).

FIG. 3 is an exploding view of another prior art (2).

FIG. 4 is an exploding view of another prior art (3).

FIG. 5 is an exploding view of another prior art (4).

FIG. 6 is an exploding view of another prior art (5).

FIG. 7 is an exploding view of another prior art (6).

FIG. 8 is an exploding view of an embodiment of the invention.

FIG. 9 is an exploding view of a control valve and an embodiment of the invention.

FIG. 10 is a cross-section view of an assembled embodiment of the invention.

FIG. 11 is an exploding view of an inlet pipe according to an embodiment of the invention (1).

FIG. 12 is a perspective view of an assembly of the embodiment according to FIG. 11.

FIG. 13 is an exploding view of an inlet pipe according to an assembly of an embodiment of the invention (2).

FIG. 14 is a perspective view of an assembly of the embodiment according to FIG. 13.

FIG. 15 is an exploding view of an inlet pipe according to an assembly of an embodiment of the invention (3).

FIG. 16 is a perspective view of an assembly of the embodiment according to FIG. 15.

FIG. 17 is an exploding view of an inlet pipe according to an assembly of an embodiment of the invention (4).

FIG. 18 is a perspective view of an assembly of the embodiment according to FIG. 17.

FIG. 19 is a perspective view of an assembly of another embodiment of the invention (1).

FIG. 20 is a cross-section of FIG. 19.

FIG. 21 is an exploding assembly view of FIG. 19.

FIG. 22 is a perspective view of an assembly of another embodiment of the invention (2).

FIG. 23 is a cross-section of FIG. 22.

FIG. 24 is an exploding assembly view of FIG. 22.

Corresponding reference characters indicate corresponding parts throughout the drawings.

### DETAILED DESCRIPTION OF THE INVENTION

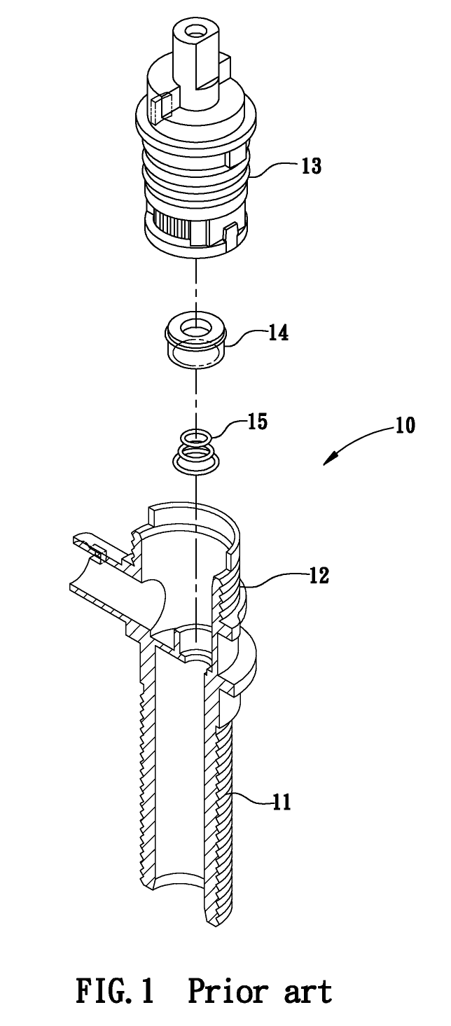

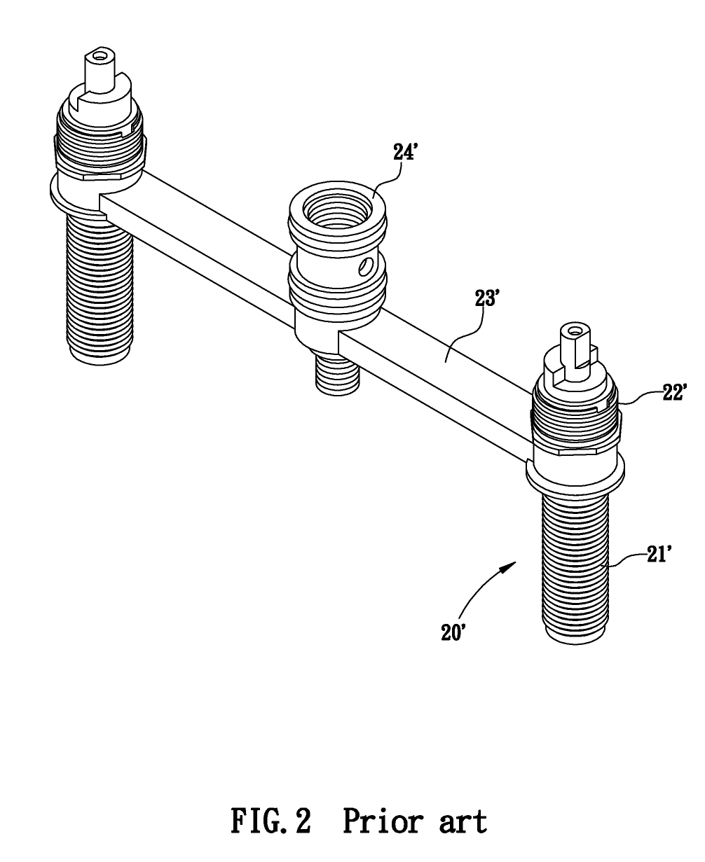

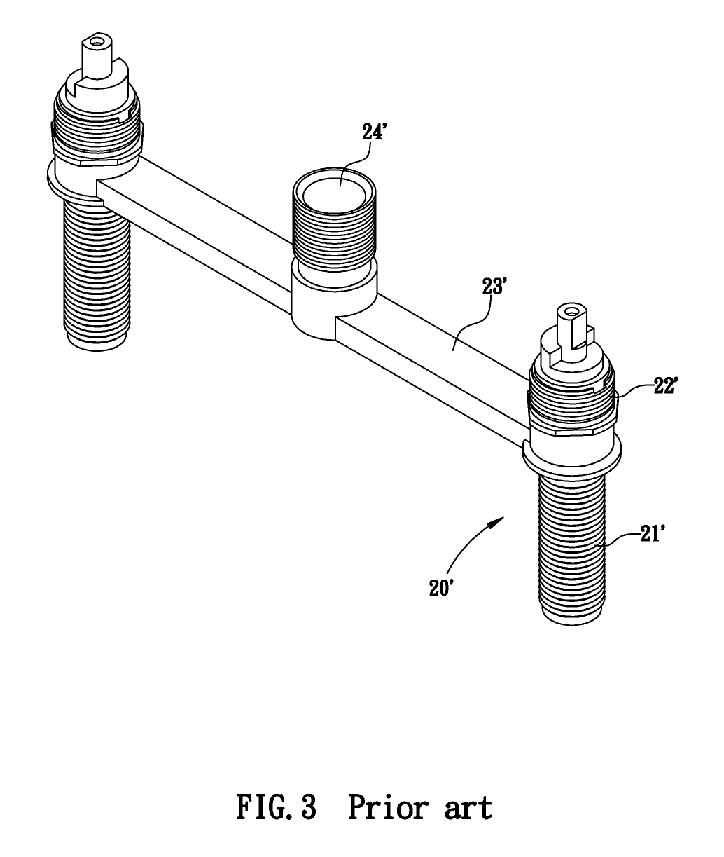

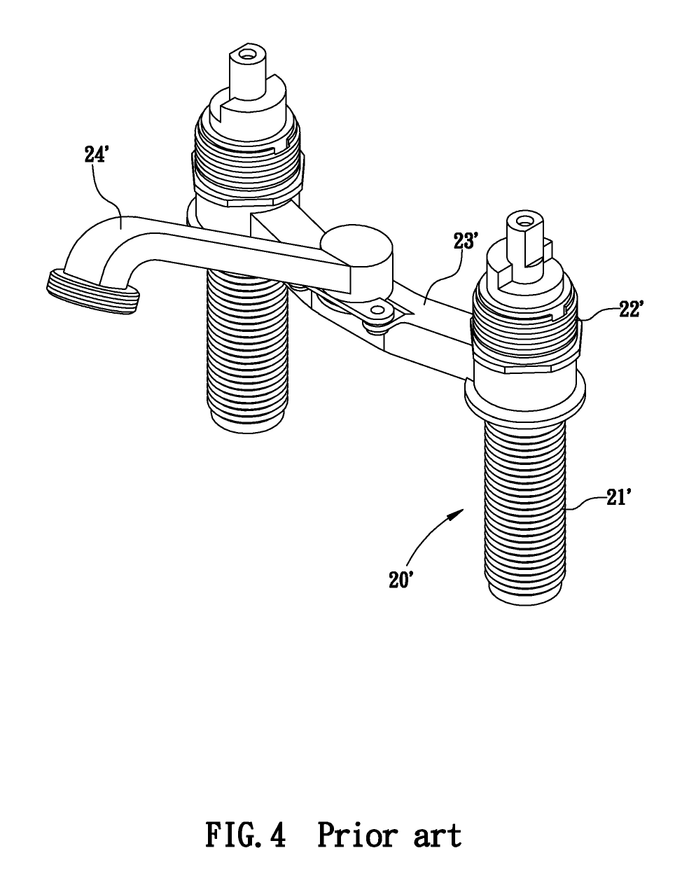

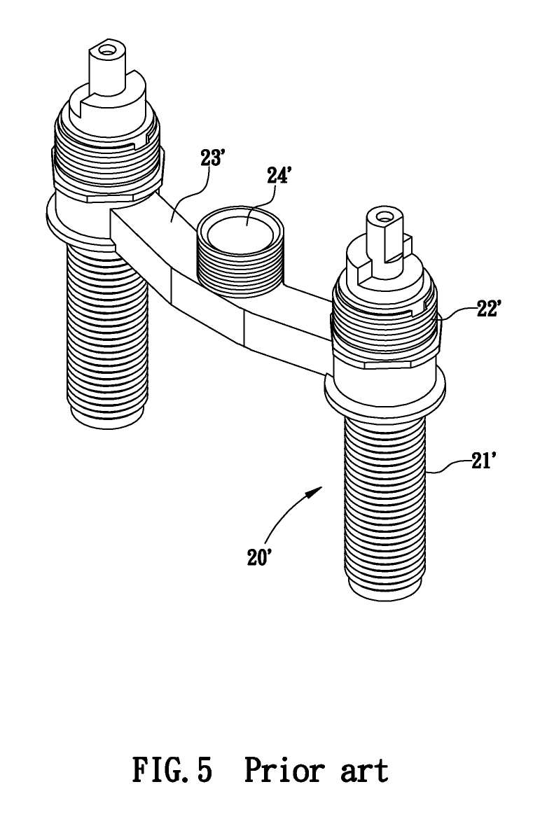

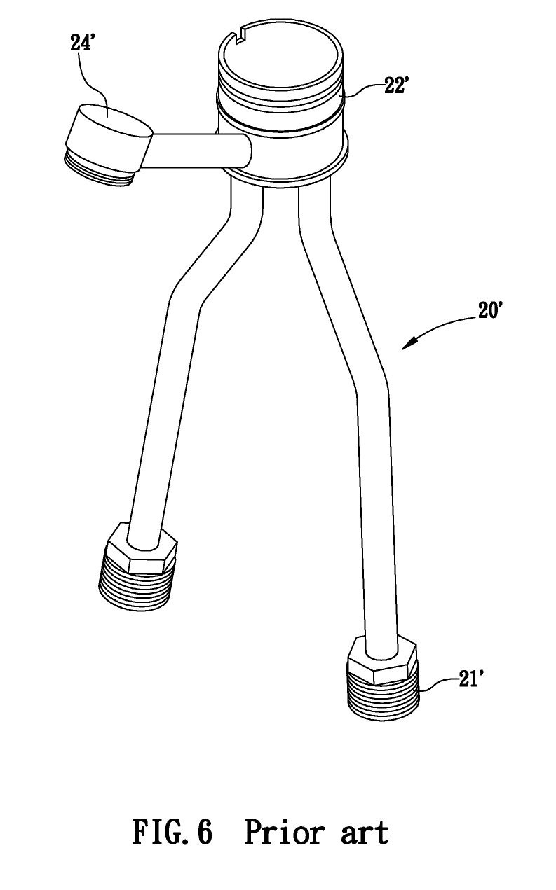

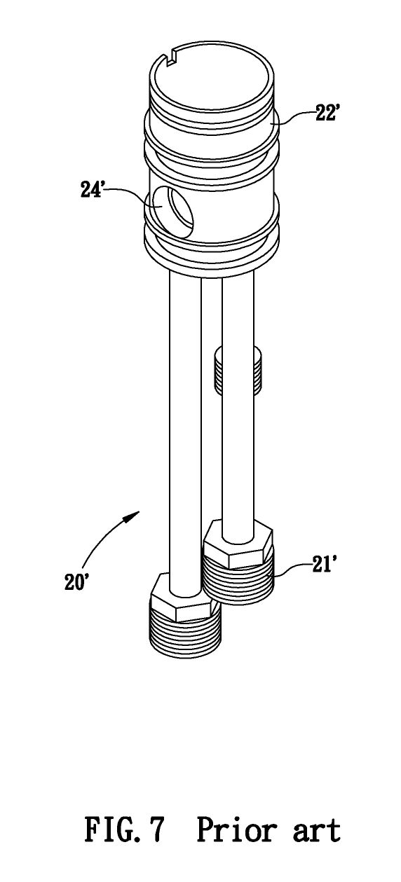

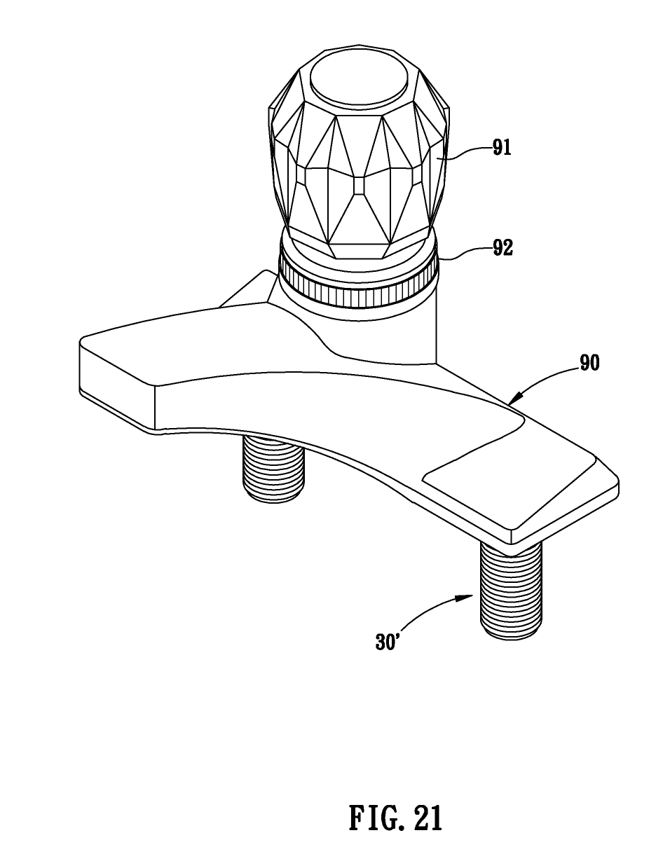

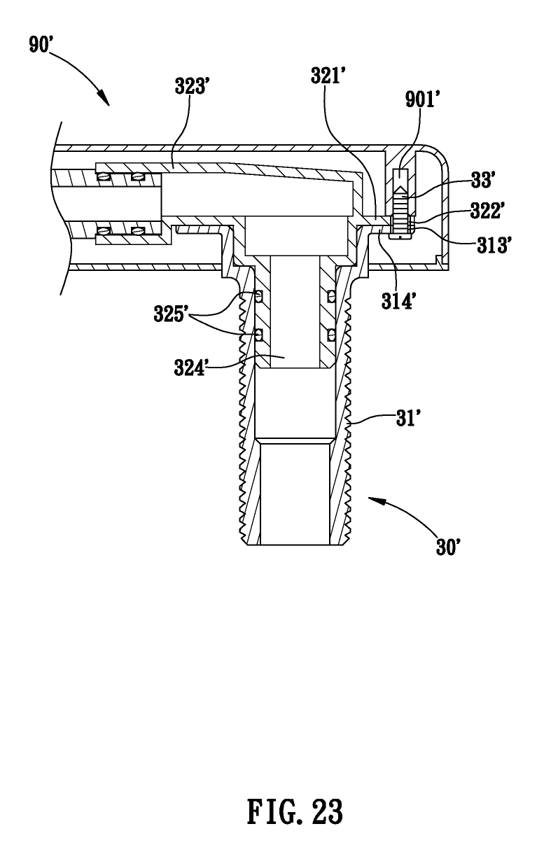

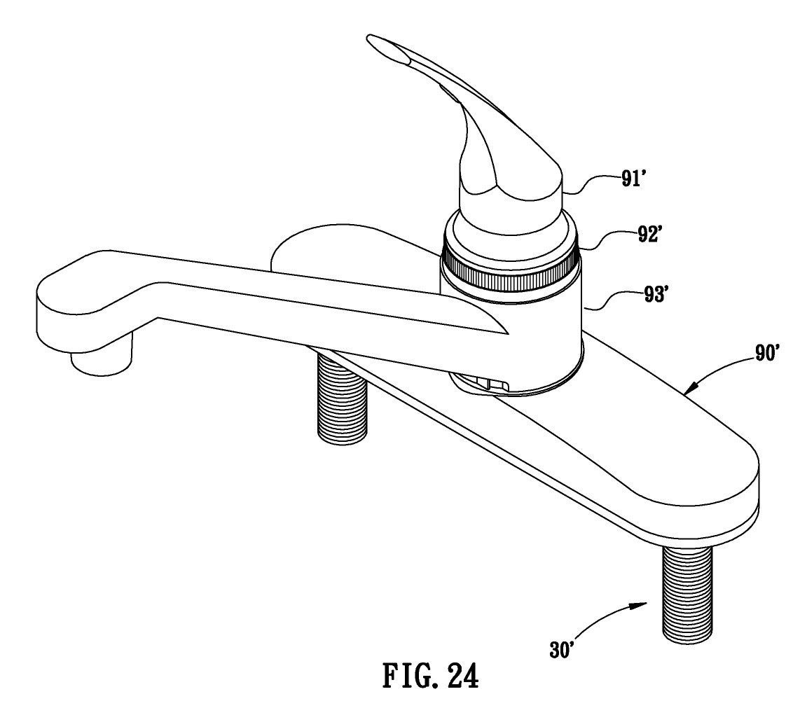

The following list shows reference characters used through FIGS. 1-24:

| | |
|---|---|
| 30 - inlet pipe | 31 - main pipe |
| 311 - ring pad | 312 - blocking pate |
| 313 - bore | 314 - plate |
| 32 - holding chamber | 321 - first ring |
| 322 - second ring | 323 - pipe section |
| 3231 - strengthening rib | 324 - externally threaded section |
| 325 - connecting pipe | 326 - stoppage ring |
| 327 - locking slot | 33 - control valve |
| 331 - locking element | 332 - shaft |
| 34 - stoppage ring | 35 - flexing piece |
| 40, 40′ - faceplate | 41, 41′ - pin |
| 42, 42′ - tightening piece | 43 - opening |
| 43′ - protruding piece | 50 - handle |
| 51 - lock cover | 60 - outlet connecting piece |
| 61 - connecting piece | 611 - stoppage ring |
| 62 - locking section | 63 - receiving base |
| 631 - opening | 60′ - outlet connecting piece |
| 61′ - connecting piece | 611′ - stoppage ring |
| 62′ - connecting member | 63′ - outlet |
| 631′ - strengthening rib | 632′ - limiting piece |
| 6321′ - limiting opening | 633′ - stoppage ring |
| 634′ - locking element | 70 - outlet |
| 71 - pin | 72 - locking element |
| 60″ - outlet | 61″ - connecting pipe |
| 611″ - strengthening rib | 62″ - connecting member |
| 621″ - stoppage ring | 622″ - interior threaded section |
| 623″ - bore | 624″ - external threaded section |
| 63″ - limiting piece | 631″ - limiting hole |
| 70′ - outlet | 71′ - cover |
| 70″ - outlet | 71″ - lock cover |
| 30′ - inlet | 31′ - main threaded pipe |
| 313′ - pin | 314′ - plate |
| 32′ - base member | 321′ - connecting plate |
| 322′ - bore | 323′ - pipe section |
| 3231′ - strengthening rib | 324′ - set connecting piece |
| 325′ - stoppage ring | 33′ - lock piece |
| 80 - outlet pipe | 81 - control valve |
| 811 - shaft | 82 - connecting pipe |
| 821 - stoppage ring | 83 - pipe section |
| 84 - holding chamber | 841 - blocking ring |
| 85 - external threaded section | 86 - connecting section |
| 87 - outlet | 871 - strengthening rib |
| 872 - limiting bore | 873 - locking element |
| 90 - faceplate | 901 - locking bore |
| 91 - handle | 92 - lock cover |
| 80′ - outlet connecting pipe | 81′ - control valve |
| 811′ - shaft | 82′ - connecting pipe |
| 821′ - stoppage ring | 822′ - strengthening rib |
| 83′ - holding chamber | 831′ - stoppage ring |
| 832′ - external threaded section | 833′ - through bore |
| 90′ - faceplate | 901′ - locking bore |
| 91′ - handle | 92′ - locking cover |
| 93′ - outlet | |

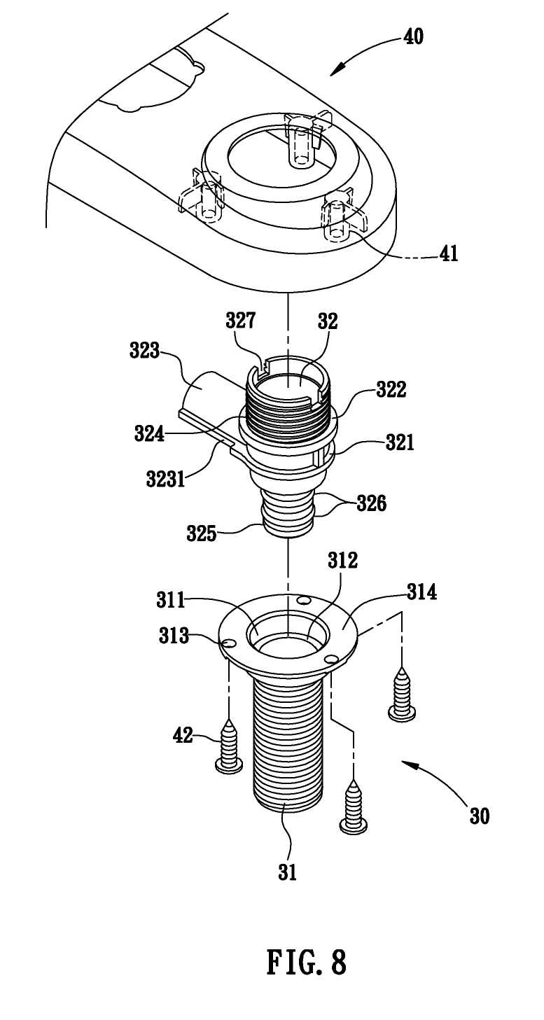

Referring to FIG. 8, an exploding view of an embodiment of the invention depicts an inlet pipe 30 includes a main pipe 31 with an externally threaded section and a holding chamber 32 as a base. In this embodiment, the main pipe 31 is made of metallic materials. In addition, at one end of the main pipe 31 includes a ring pad 311, and the ring pad 311 has a diameter that is larger than that of the main pipe 31. The ring pad 311 is coupled to a blocking plate 312 and, together, they are coupled to a plate 314 with one or more bores 313 thereon. In one embodiment, the bores 313 on the plate 314 match with one or more pins 41 on a faceplate 40. A holding chamber 32 is composed of non-toxic materials that are resistant to weather and pressure. The holding chamber 32 includes a first ring 321 and a second ring 322 on the exterior surface thereof. The holding chamber 32 includes a pipe section 323 coupled thereto and protruding between the first ring 321 and the second ring 322 from the holding chamber 32. In one embodiment, the pipe section 323 and the holding chamber 32 are interconnected. Surfaces of the pipe section 323 include one or more strengthening ribs 3231 in order to strengthening the integrity of the pipe section 323. The holding chamber 32 includes an externally threaded section 324 above the second ring 322 and to one distal end of the holding chamber 32. For illustration purpose only, this end is the top end. On the other end of the holding chamber 32 (for illustration purpose only, this is the bottom end), the holding chamber is coupled to a connecting pipe 325. The connecting pipe 325 includes two or more stoppage rings 326 on its exterior surface thereof. On the other end of the holding chamber 32, one or more locking slots 327 are disposed coupled to the externally threaded section 324.

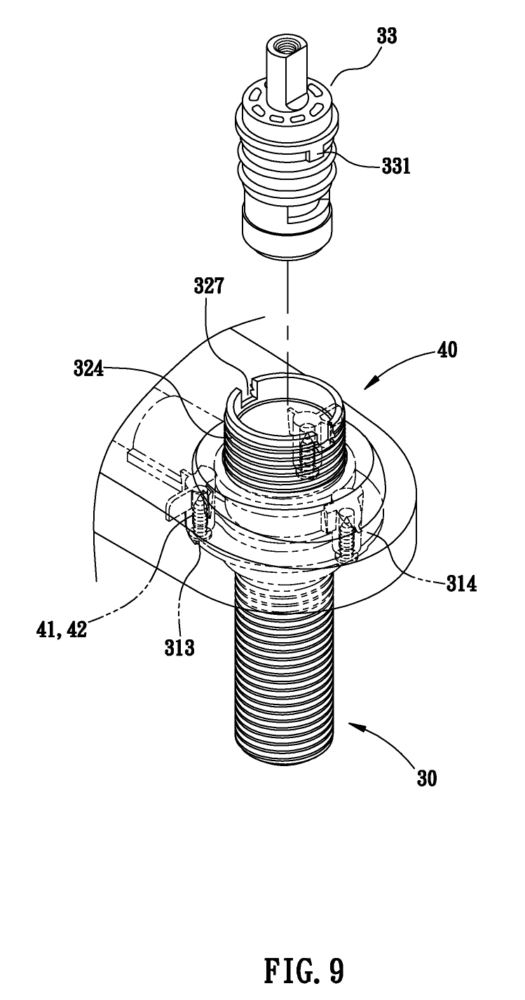

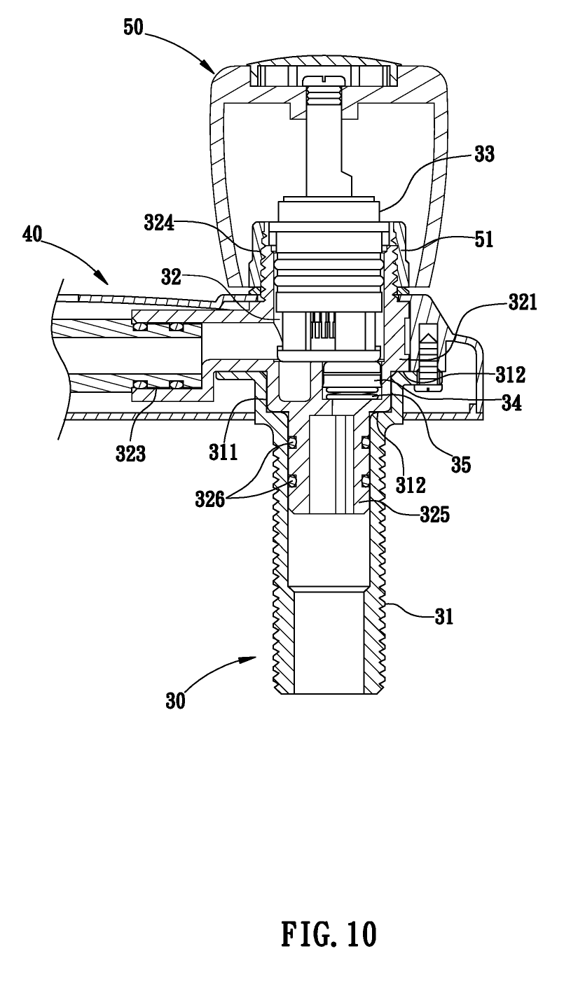

In assembly, as shown in FIGS. 9 and 10, one only needs to fit the connecting pipe 325 at the bottom end of the holding chamber 32 into an opening of the main threaded section 31. As such, the stoppage rings 326 on the exterior surface of the connecting pipe 325 are fitted against the interior wall of the main threaded section 31. The bottom of the holding chamber is fitted in the ring pad 311 and is biased against the blocking plate 312. The first ring 321 is also fitted against the plate 314. This kind of assembly is convenient, less time-consuming, highly cost-effective, and consumes less metallic materials. In a further embodiment, a control valve 33 having a stoppage ring 34 and a flexing piece 35 is fitted inside the holding chamber 32. In addition, one or more locking elements 331 of the control valve 33 fit into corresponding locking slots 327. To continue the assembly, the pins 41 of the faceplate 40, as well as a lock cover 51 and a handle 50, are fitted with the bores 313 of the inlet pipe 30. The inlet pipe 30 is further tightened with the remaining parts using tightening pieces 42 and the externally threaded section 324. As such, the faceplate 40 and the inlet pipe 30 are coupled tightly and securely to avoid loosening due to impact.

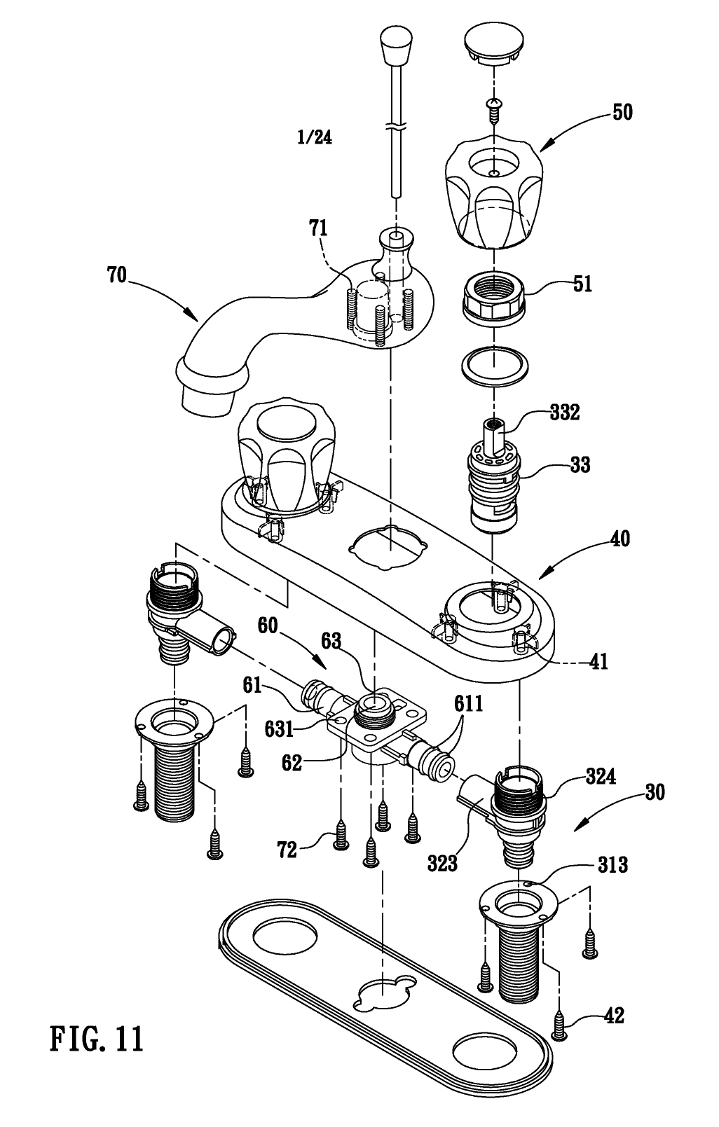

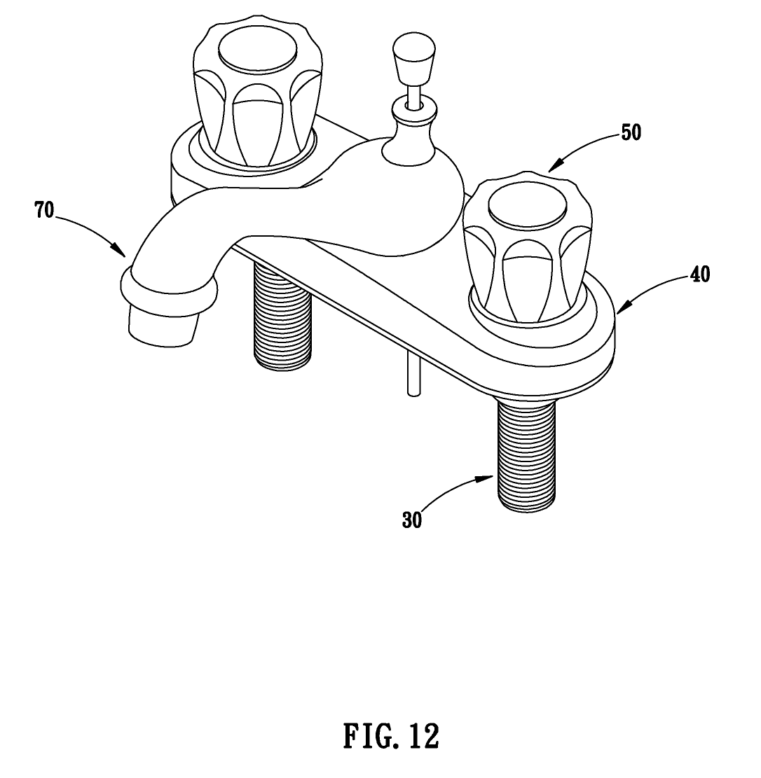

Referring to FIGS. 11 and 12, the inlet pipe 30 is coupled to an outlet connecting piece 60. Each end of the outlet connecting piece 60 is coupled to a connecting piece 61. As such, there are two inlet pipes 30 on each end of the outlet connecting piece 60 and the pipe section 323 of each inlet pipe 30 is responsible for cold or hot water outlet. The connecting piece 61 also includes two or more stoppage rings 611 for coupling to the pipe section 323. A receiving base 63 and a locking section 62 are disposed at the middle part of the outlet connecting piece 60. The receiving base 63 includes one or more openings 631. The one or more openings 631 are designed to receive pins 71 of the outlet 70. Thereafter, the faceplate 40, the handle 50, and the lock cover 51 are subsequently coupled to the externally threaded section 324, the control valve 33 of the inlet pipes 30, as well as a shaft 332. At the same time, the pins 41 of the faceplate 40 fit into the bores 313 of the inlet pipe 30. Similarly, the openings 631 of the outlet connecting piece 60 and the pins 71 of the outlet 70 are corresponding pieces such that the outlet connecting piece 60 is coupled to the outlet 70 securely. In addition, tightening pieces 42 and locking elements 72 are used to further secure and complete the assembly of a faucet to enable hot water and cold water to a user. As such, the pipe section 323 of the inlet pipe 30 can couple to a variety of outlet connecting piece 60 to couple with a faceplate 40 and a handle 50 of various designs to suit consumer's or user's needs and increase competitiveness in the market place. Moreover, the stoppage rings 611 of the connecting pieces 61 and the pipe section 323 of the inlet pipe 30 further increases the maximum amount of water leakage prevention.

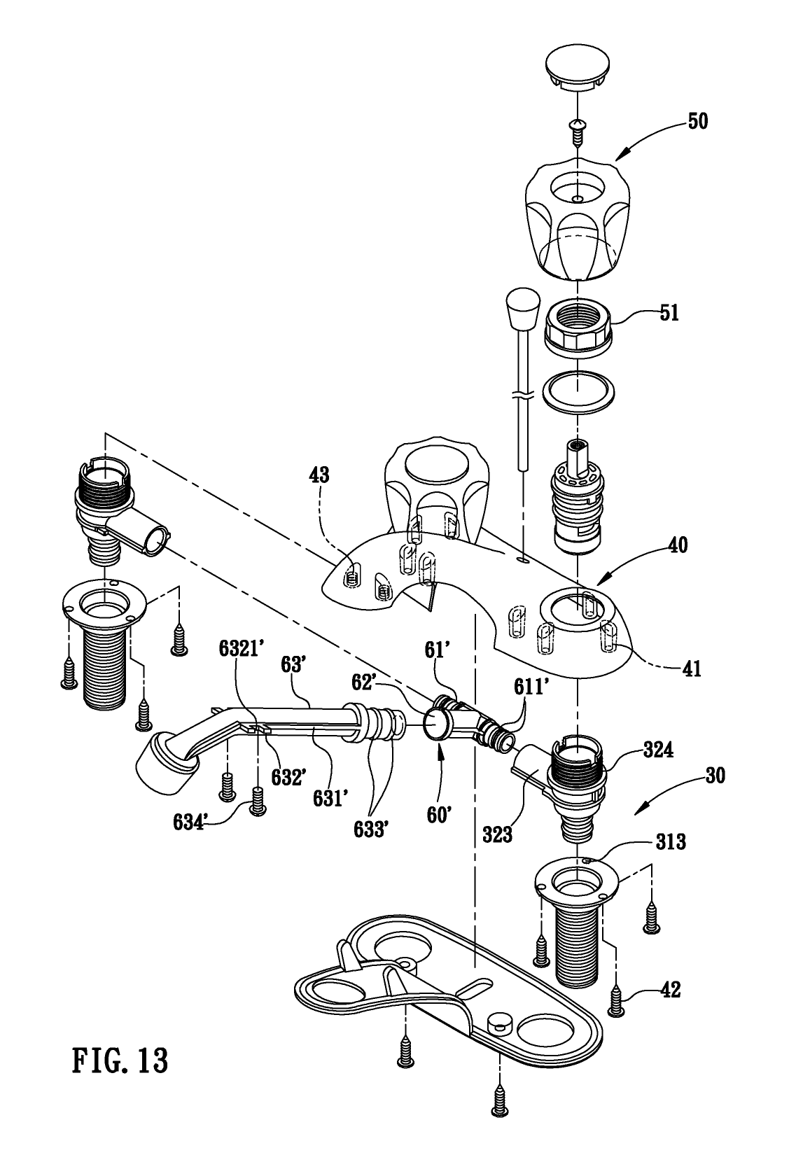

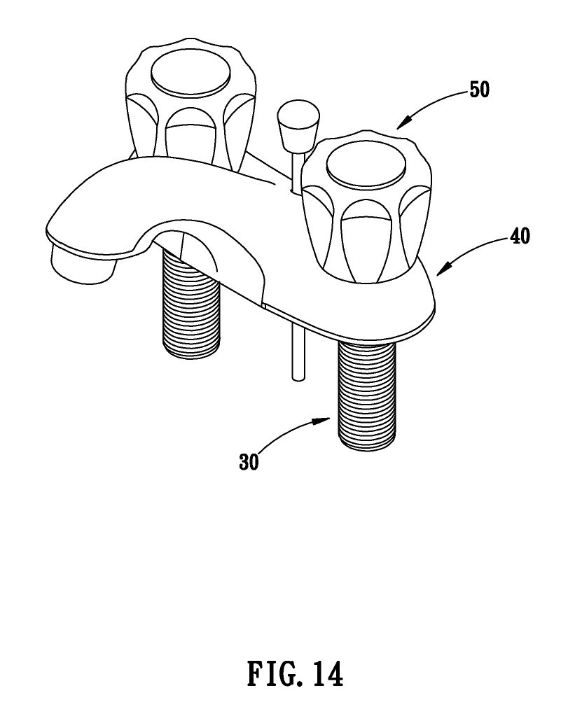

Referring to FIGS. 13 and 14, an outlet connecting piece 60′ forms a reverse “T” shape and includes a connecting piece 61′ on each end of the outlet connecting piece 60′. Each of the connecting piece 61′ also includes a pipe section 323 to be connected to the hot water and cold water pipes. At the top end of the connecting member 62′ and it is coupled to an outlet 63′. The outlet 63′ includes one or more strengthening ribs 631′ on the surface thereof and the two side thereof includes a “M” shaped limiting piece 632′ to form a limiting opening 6231′ to receive locking elements 634′ through the openings 43 to hold the faceplate 40 in place. The connecting piece 61′ and the outlet 63′ further include the stoppage rings 611′ and 633′ to enhance water seepage prevention. Thereafter, a faucet is formed once the faceplate 40 is assembled with the inlet pipe 30 by coupling the faceplate 40 through the opening 41 with the handle 50 through the lock cover 51. In addition, the inlet pipe 30 is coupled thereto through the externally threaded section 324 and the bore 313. Through such an assembly, the assembled faucet has enhanced pressure resistance characteristics, is economically efficient and enhances market competitiveness.

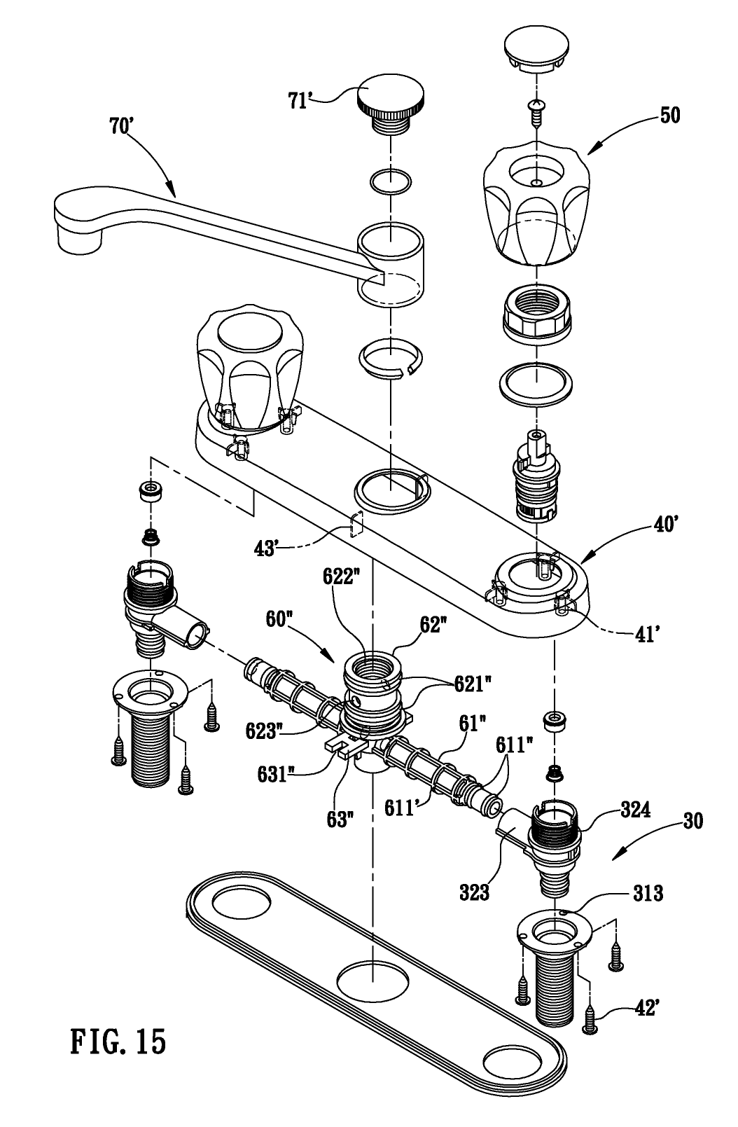

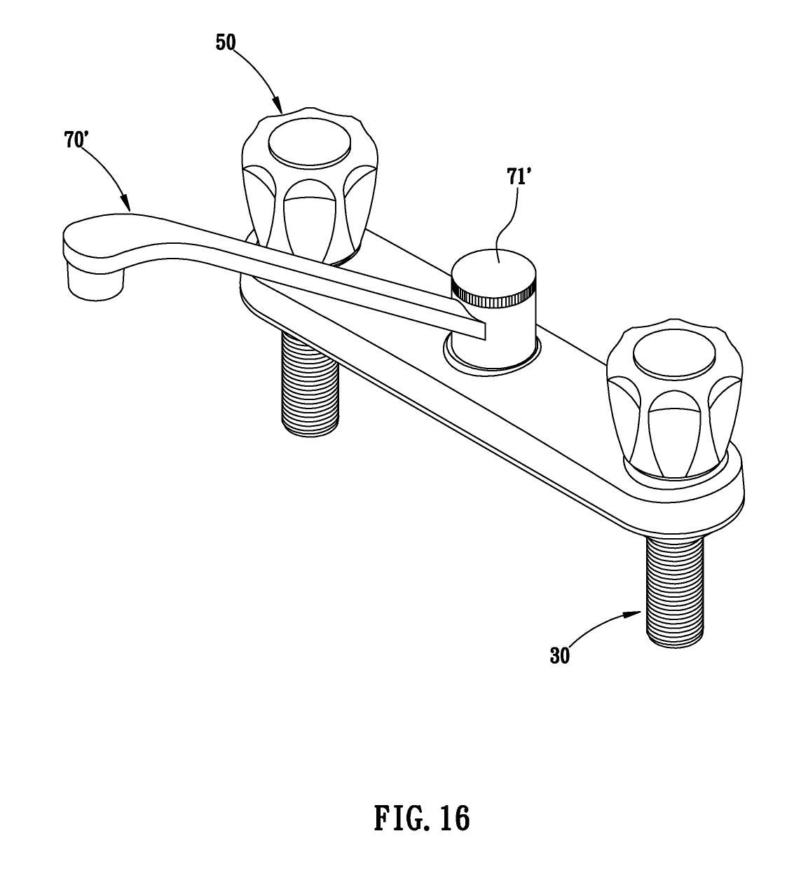

Referring to FIGS. 15 and 16, the two sides of an outlet 60″ includes a connecting pipe 61″ that can conveniently and flexibly fit with faceplates 40′ with different sizes. In addition, in assembly, the connecting pipes 61″ extend to the pipe section 323 to the inlet pipe 30. The surface of the connecting pipes 61″ includes strengthening 611″ having straight and ring-like structure to strengthen the overall durability and stability of the unit. A limiting piece 63″ having an “M” shape forms a limiting hole 631″. An external surface of a connecting member 62″ includes two stoppage rings 621″. On one side includes an interior threaded section 622″ and a cover 71′ such that the connecting member 62″ is tightened against the outlet 70′. In addition, the two stoppage rings 621″ include a bore 623″ and the opening of the outlet 70′ is correspondingly matched to said bore 623″ to allow water to exit. The faceplate 40′ also includes a number of pins 41′ and a protruding piece 43′ at the bottom thereof, and the bores 313 of the inlet pipe 30 correspondingly provides a tightening piece 42′ to tighten the faceplate 40′. The assembled piece is set on the outlet connecting piece 60″ with the protruding piece 43′ fitted into a limiting piece 631′ to achieve maximum stability and increase the amount of water pressures handled by the assembled unit.

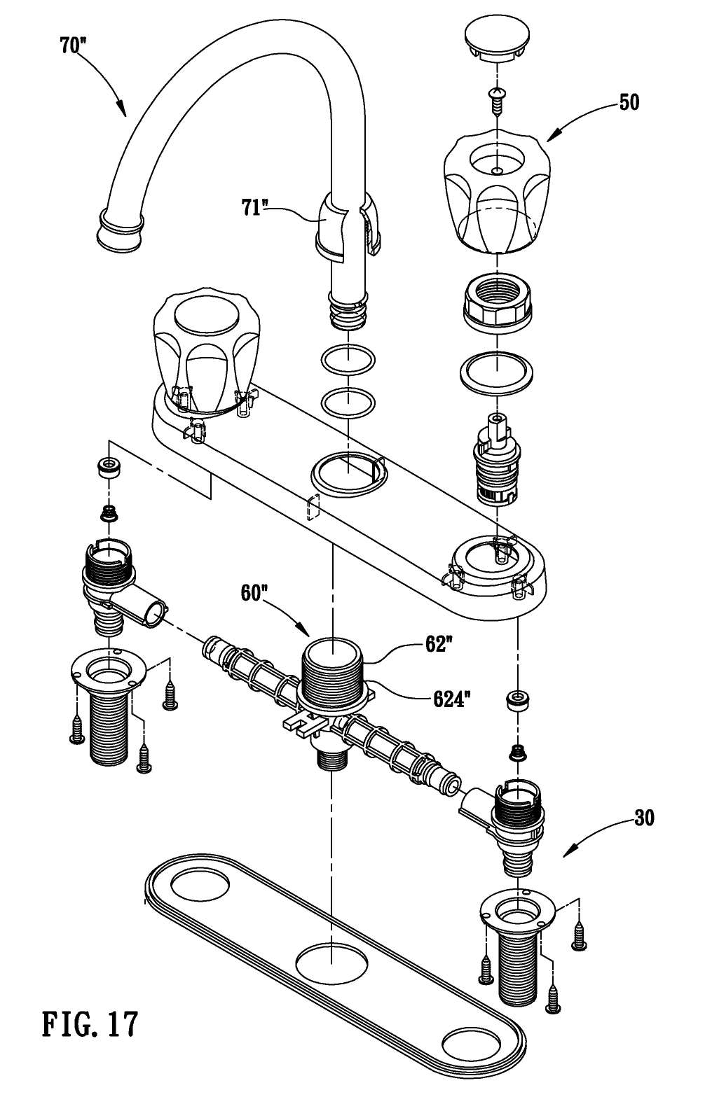

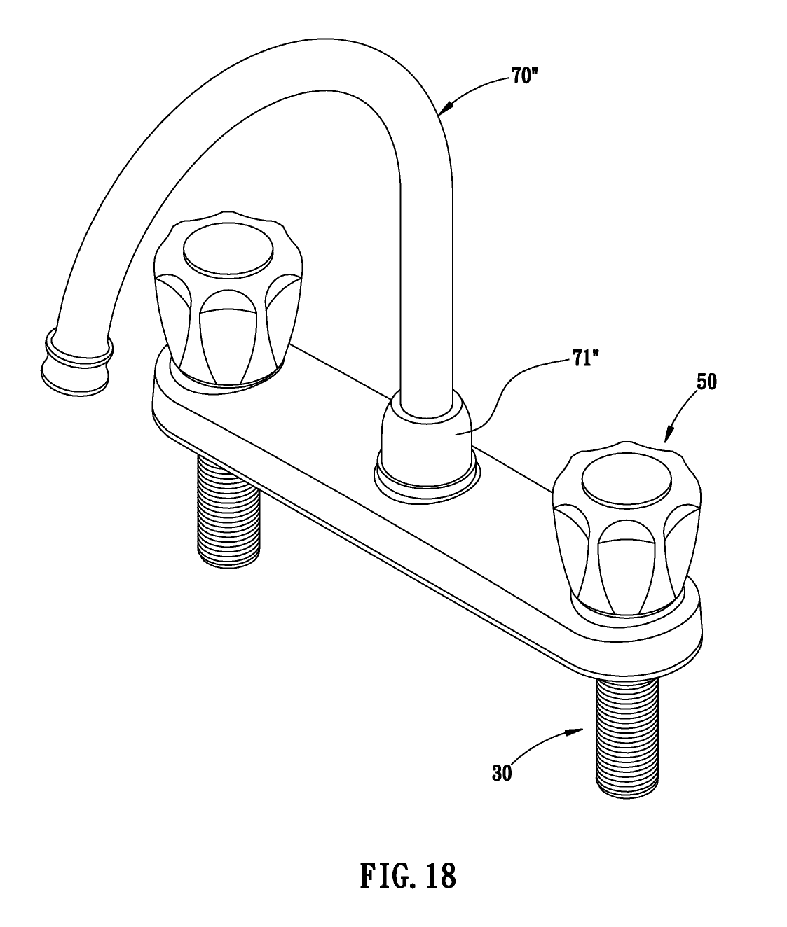

Referring further to FIGS. 17 and 18, the connecting member 62″ of the outlet connecting piece 60″ includes an external threaded section 624″ and the external threaded section 624″ is coupled to a lock cover 71″ of a outlet 70″ in a shape of the number “7” to provide an outlet for the water.

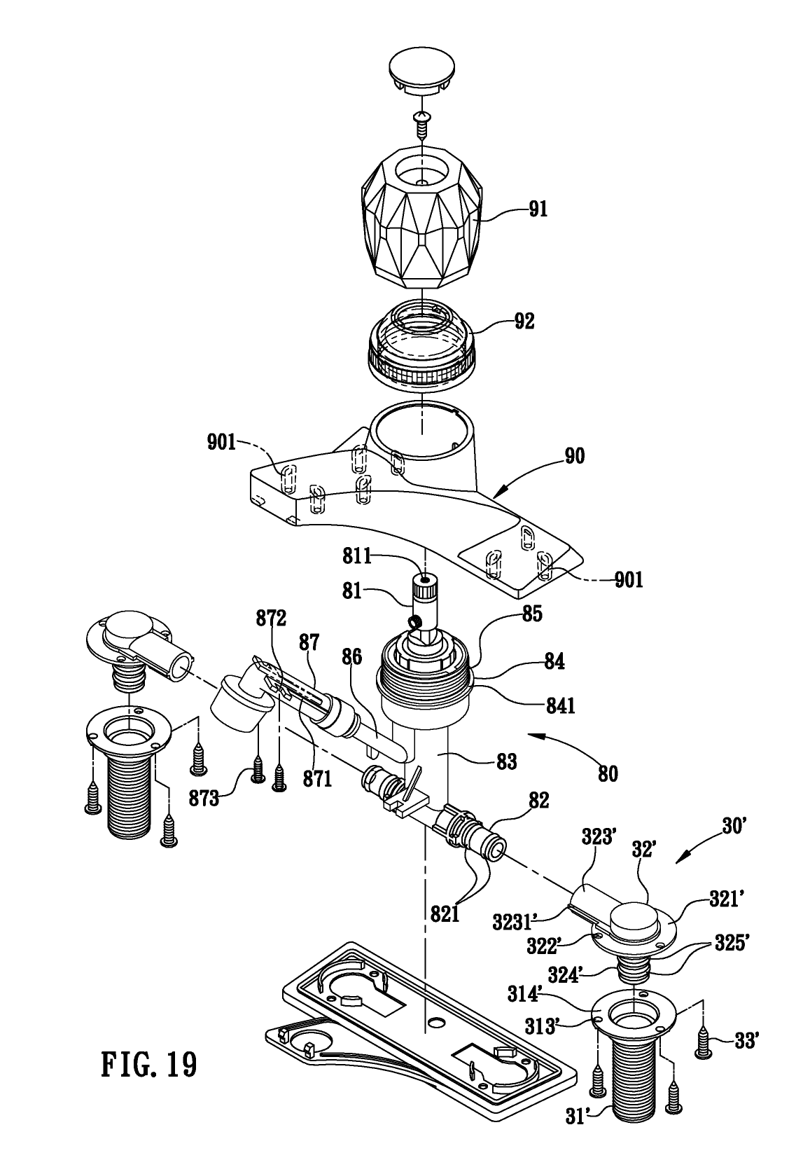

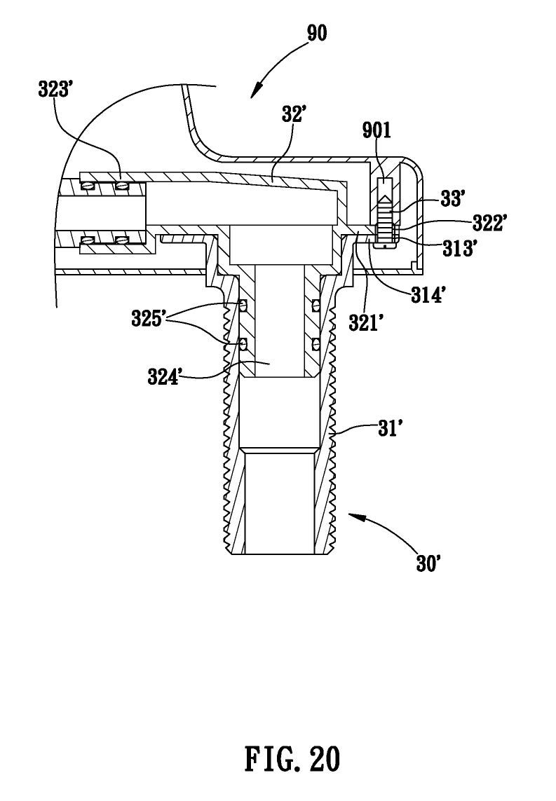

Referring now to FIGS. 19 and 20, the inlet pipe 30′ is composed of a metallic main threaded pipe 31′ and a base member 32′ made of non-toxic, pressure resistant, and weather resistant plastic materials. The base member 32′ includes a connecting plate 321′ that is correspondingly matched to a plate 314′ of the main threaded pipe 31′. The connecting plate 321′ includes a number of bores 322′ and the bores 322′ corresponding match with pins 313′ of the plate 314′ such that the bores 322′ receive the pins 313′. The connecting plate 321′ also includes a pipe section 323′ on its side thereof, and the pipe section 323′ includes strengthening ribs 3231′ on its surface thereof to further strengthen the integrity of the pipe section 323′. The base member 32′ includes a set connecting piece 324′ at the bottom thereof. The set connecting piece 324′ is of a smaller diameter is coupled to the pipe section 323′. The set connecting piece 324′ includes at least two stoppage rings 325′ disposed on the exterior of the set connecting piece 324′ and the stoppage rings 325′ are biased against the inner wall of the main threaded pipe 31′ to achieve optimal water seepage effect. The inlet pipe 30′ also includes an outlet pipe 80 of a control valve 81, a handle 91, and a faceplate 90 with a lock cover 92. The outlet pipe 80 includes a connecting pipe at each side thereof and the pipe section 323′ of the inlet pipe 30′ to provide outlets for hot and cold water. The connecting pipe 82 includes at least two stoppage ring 821 at an appropriate location thereof. The outlet pipe 80 also extends upward to a pipe section 83 and coupled to a receiving chamber 84. The receiving chamber 84 includes a blocking ring 841, and an external threaded section 85 is disposed at the top of the blocking ring 841. The receiving chamber 84 includes a connecting section 86 at the bottom of the receiving chamber 84, and the connecting section 86 is coupled to an outlet 87. The outlet 87 includes two strengthening ribs 871 of the shape “F” and forms a limiting bore 872 to strengthen the integrity thereof. In assembly, the control valve 81 is first set inside the receiving chamber 84. Then, the lock cover 92 of the faceplate 90 and the handle 91 are consecutively coupled to the external threaded section 85 of the outlet pipe 80, as well as a shaft of the control valve 81. The above parts are securely tightened. The faceplate 90 includes one or more locking bores 901 that are disposed to match with the pins 313′ and bores 322′ of the inlet pipe 30′ and the limiting bore 872 of the outlet 87 such that the locking piece 33′ and the locking element 873 can hold the parts securely. As such, the inlet 30′ is assembled to become a faucet.

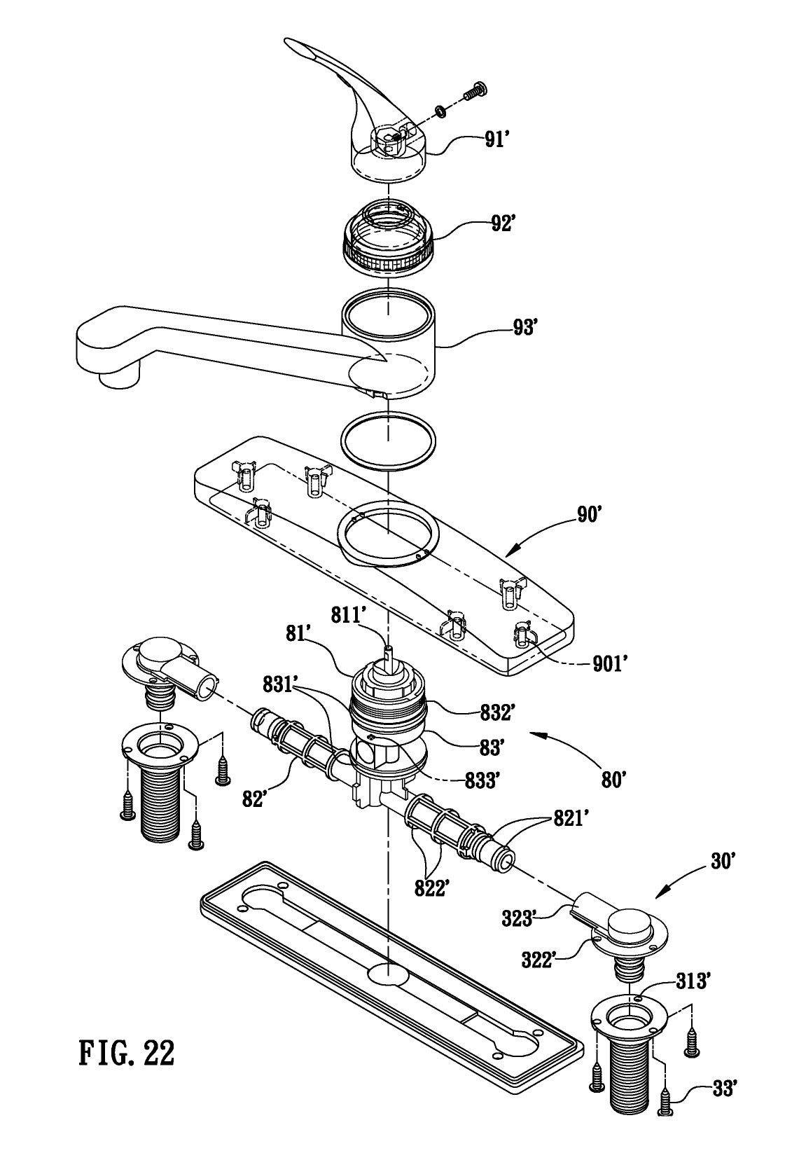

Referring to FIGS. 22 to 24, an outlet connecting pipe 80′ includes a connecting pipe 82′ on each of the two sides of the outlet connecting pipe 80′ and may be fitted with a faceplate 90′ of different sizes. The outlet connecting pipe 80′ may then be extended to be coupled with the pipe section 323′ of the inlet pipe 30′ in assembly. The connecting pipe 82′ includes a number of straight and ring-shaped strengthening ribs 822′ and is fitted with two or more stoppage rings 821′ to increase overall stability and water seepage effect. In the middle, a receiving chamber 83′ includes two stoppage rings 831′ with one side includes an external threaded section 832′. A through bore 833′ is disposed between the two stoppage rings 831′ and an outlet 93′ of the faceplate 90′ is aligned thereto to provide an outlet for water. A control valve 81′ is disposed in the receiving chamber 83′ and is secured therein with a locking cover 92′ of the faceplate 90′ and a handle 91′ consecutively. The external threaded section 832′ of the outlet connecting pipe 80′ and a shaft 811′ of the control valve 81′ is further secured with each other. The faceplate 90′ also includes one or more locking bore 901′ and the pins 313′ and the bores 322′ of the inlet pipe 30′ are secured by the lock piece 33′ to achieve optimal effects of securing the parts in place and pressure resistance of the faucet.

Although the invention has been explained in relation to its various embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

Having described the invention in detail, it will be apparent that modifications and variations are possible without departing from the scope of the invention defined in the appended claims.

When introducing elements of the embodiments(s) of the present invention, the articles “a”, “an”, the and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions or products without departing from the scope of the invention, it is intended that all matter contained in the above description and shown in the accompanying drawing[s] shall be interpreted as illustrative and not in a limiting sense.

What is claimed is:

1. A faucet structure, comprising:
an inlet pipe including a metallic main pipe; and
a receiving chamber of non-toxic, weather-resistant, and pressure-resistant plastic materials,
said inlet pipe disposing a ring pad to form a blocking plate, said ring pad having a larger diameter, said ring pad having a number of bores disposed on top thereof to form a plate with a diameter larger than that of the ring pad,
said receiving chamber including a first ring and a second ring disposed on the exterior thereof,
said receiving chamber further including a pipe section disposed on the second ring and includes an external threaded section on top of the second ring,
a connecting pipe of said receiving chamber being disposed at the bottom thereof, said connecting pipe having a smaller diameter than that of the receiving chamber,
said connecting pipe including at least two stoppage rings on exterior surfaces thereof, and
said stoppage rings being fitted inside the inlet pipe to form the faucet structure.

2. The faucet structure of claim 1, wherein the receiving chamber includes an opening having a number of locking slots to be fitted with corresponding locking elements of a control valve.

3. The faucet structure of claim 1, wherein the pipe section comprises one or more strengthening ribs protruding from surfaces of the pipe section.

4. A faucet structure, comprising:
an inlet pipe including a metallic main pipe; and
a base member of non-toxic, weather-resistant, and pressure-resistant plastic materials,
said inlet pipe disposing a ring pad to form a blocking plate, said ring pad having a larger diameter, said ring pad having a number of bores disposed on top thereof to form a plate with a diameter larger than that of the ring pad,
said base member including a connecting plate to be fitted with the plate of the inlet pipe,
said connecting plate including one or more bores thereon to be matched correspondingly to bores of the plate of the inlet pipe and including a pipe section on one side thereof,
said base member including at least two stoppage rings on a set connecting piece coupled at the bottom of the base member,
said set connecting piece coupling to and fitting inside the inlet pipe to form the faucet structure.

5. The faucet structure of claim 4, wherein the pipe section comprises one or more strengthening ribs protruding from surfaces of the pipe section.
